(19) United States
(12) Patent Application Publication
(10) Pub. No.: US 2017/0144905 A1
(43) Pub. Date: May 25, 2017

(54) Removal of Heavy Metals from Water Contaminated with Heavy Metals by Precipitation of Calcium Carbonate

(71) Applicant: CDM Smith Inc., Boston, MA (US)

(72) Inventor: Kent Whiting, Helena, MT (US)

(21) Appl. No.: 15/359,220

(22) Filed: Nov. 22, 2016

Related U.S. Application Data
(60) Provisional application No. 62/259,440, filed on Nov. 24, 2015.

(51) Int. Cl. C02F 1/52; C02F 1/66

(52) U.S. Cl. CPC C02F 1/5236; C02F 1/66; C02F 1/5209; C02F 2101/20

(57) ABSTRACT

Described are methods of removing one or more heavy metals from water. A source of calcium carbonate is added to the water, which is treated to cause coprecipitation of calcium carbonate and the one or more heavy metals. Then, the coprecipitated calcium carbonate and one or more heavy metals are separated from the water.

### RELATED APPLICATION

This application claims the benefit of U.S. Provisional Application No. 62/259,440, filed on Nov. 24, 2015. The entire teachings of the above application are incorporated herein by reference.

### BACKGROUND

An adit is a sloping tunnel that drains water from a mine, which is commonly referred to as adit water. Often times, the adit water is contaminated with heavy metals, such as cadmium, lead, zinc, copper, and others. These heavy metals are toxic, and therefore removal of the heavy metals from the adit water is desirable. Heavy metals are also common in other contaminated water, such as industrial waste water.

Heavy metals are typically removed from adit water, or other water contaminated with heavy metals, by adjusting the pH to values greater than 9 using a strong base, such as caustic soda (NaOH) or lime (CaO). The process produces a relatively low-density sludge that can be difficult to dewater, and disposal can be expensive. In addition, the pH of the treated water must be adjusted to near-neutral values using acid prior to discharge. Furthermore, the typical precipitation treatment is limited to active treatment systems. Passive treatment systems for the removal of heavy metals, such as sulfate-reducing bioreactors (SRBs) for treating mine-impacted waters exist, but tend to be relatively inefficient for metals such as zinc. Further, SRBs require the presence of sulfate within the water to be treated.

Thus, improved methods of removing heavy metals from water, such as adit water, industrial waste water, or other contaminated water, are desirable.

### SUMMARY OF THE INVENTION

Described herein is a method of removing one or more heavy metals from water contaminated with one or more heavy metals. The method includes adding a source of calcium carbonate to the water under conditions to produce a solution of calcium carbonate, and treating the solution of calcium carbonate to cause coprecipitation of calcium carbonate and the one or more heavy metals. The method can also include separating the coprecipitated calcium carbonate and one or more heavy metals from the water.

The method can also include determining the pH of the water prior to adding a source of calcium carbonate to the water. If the pH of the water is higher than desired, the method can include treating the water to produce lower-pH water having a desired pH prior to adding a source of calcium carbonate to the water. Treating the water to produce lower-pH water can be performed by adding acid to the water or bubbling carbon dioxide through the water.

Treating the solution of calcium carbonate to cause coprecipitation of calcium carbonate and the one or more heavy metals can include raising the pH of the solution of calcium carbonate, such as by adding base to the solution or stripping carbon dioxide from the solution. Stripping carbon dioxide from the solution of calcium carbonate can be performed by bubbling air through the solution.

In some instances, treating the solution of calcium carbonate to cause coprecipitation of calcium carbonate and the one or more heavy metals is accomplished by adding a sufficient source of calcium carbonate to produce a saturated solution of calcium carbonate. The source of calcium carbonate can be limestone. In some instances, the source of calcium carbonate can be two separate reagents, such as example calcium chloride and sodium carbonate.

Adding a source of calcium carbonate can be accomplished by adding reactants, such as calcium chloride and sodium carbonate, that form sufficient calcium carbonate to produce a saturated solution of calcium carbonate.

In some instances, the heavy metals removed from the water include cadmium, lead, zinc, copper, manganese, nickel or combinations thereof.

The methods can be performed on water contaminated with one or more heavy metals. Examples include adit water and industrial waste water.

Also described herein is a method of removing one or more heavy metals from adit water contaminated with one or more heavy metals. The method includes bubbling carbon dioxide through the water, adding a source of calcium carbonate to the water under conditions to produce a solution of calcium carbonate, bubbling air through the solution of calcium carbonate to coprecipitate calcium carbonate and the one or more heavy metals, and separating the coprecipitated calcium carbonate and one or more heavy metals from the water.

The methods described herein provide a number of advantages. The methods produce a denser sludge than is typically produced using conventional treatment processes that employ lime or caustic soda. The methods can be applied passively in remote locations with minimal maintenance and power requirements. In a passive setting, the methods can be used to treat water to lower levels of some heavy metals than is practiced with sulfate-reducing bioreactors. The methods can be applied in a passive setting for waters low in sulfate, unlike sulfate-reducing bioreactors, which require relatively high sulfate concentrations in the water to be treated. The methods can be used for primary, stand-alone treatment or as a component of a treatment system employing other technologies.

### BRIEF DESCRIPTION OF THE DRAWINGS

The foregoing will be apparent from the following more particular description of example embodiments of the invention, as illustrated in the accompanying drawings.

FIG. 1A is a bar graph illustrating batch test results for removal of cadmium from adit water by employing precipitation with calcium carbonate.

FIG. 1B is a bar graph illustrating batch test results for removal of lead from adit water by employing precipitation with calcium carbonate.

FIG. 1C is a bar graph illustrating batch test results for removal of zinc from adit water by employing precipitation with calcium carbonate.

FIG. 2A is a graph illustrating column testing results for removal of cadmium from adit water by employing precipitation with calcium carbonate.

FIG. 2B is a graph illustrating column testing results for removal of lead from adit water by employing precipitation with calcium carbonate.

FIG. 2C is a graph showing column testing results for removal of zinc from adit water by employing precipitation with calcium carbonate.

FIG. 3A is a photomicrograph of CO2-EFF zinc-bearing calcium carbonate precipitate.

FIG. 3B is a photomicrograph of CO2-EFF zinc-bearing calcium carbonate precipitate false color image showing the distribution of zinc within the grains.

FIG. 4A is a bar graph illustrating dissolved cadmium concentration in adit water. Pre-stripping and output for limestone only and limestone plus carbon dioxide are illustrated.

FIG. 4B is a bar graph illustrating dissolved lead concentration in adit water. Pre-stripping and output for limestone only and limestone plus carbon dioxide are illustrated.

FIG. 4C is a bar graph illustrating dissolved zinc concentration in adit water. Pre-stripping and output for limestone only and limestone plus carbon dioxide are illustrated.

FIG. 4D is a bar graph illustrating dissolved calcium lead concentration in adit water. Pre-stripping and output for limestone only and limestone plus carbon dioxide are illustrated.

FIG. 4E is a bar graph illustrating total alkalinity in adit water. Pre-stripping and output for limestone only and limestone plus carbon dioxide are illustrated. Total alkalinity measures mostly the carbonate (CO₃⁻²) and bicarbonate species (HCO₃⁻).

FIG. 4F is a bar graph illustrating pH in adit water. Pre-stripping and output for limestone only and limestone plus carbon dioxide are illustrated.

FIG. 5A is a graph of calcite precipitated (mg/L) vs. initial pH.

FIG. 5B is a graph of calcite precipitated (mg/L) vs. added acidity (mg CaCO₃/L).

### DETAILED DESCRIPTION OF THE INVENTION

A description of example embodiments of the invention follows. While portions describe an example pertaining to adit water, the principles are generally applicable to other water sources that are contaminated with heavy metals, such as industrial waste water. Water contaminated with one or more heavy metals refers to water containing an undesirably high concentration of one or more heavy metals.

In order to remove heavy metals from water containing one or more heavy metals, an optional preliminary step is to determine the pH of the water. If the pH is too high, the water can be treated to produce lower-pH water having a desired pH. If the pH is known to be too high, it is not necessary to determine the precise pH of the water prior to treating the water to produce pH water having a desired pH. The desired pH depends on the concentrations of metals in the untreated water and the desired concentration levels in the treated water. Typically, the desired concentration in treated water is determined by a surface water standard, which varies according to the hardness of the water and which ranges from about 37 μg/L to about 388 μg/L for zinc. The larger the amount of metals to be removed and the lower the surface water standard, the lower the desired pH. For example, to decrease 2,000 μg/L zinc to less than 100 μg/L requires that the pH of the water be lowered to about 5 or less. The pH can be lowered by, for example, adding acid or carbon dioxide gas. By lowering the pH, the water becomes undersaturated with respect to calcium carbonate. Increased dissolution of calcium carbonate is preferable because the heavy metals coprecipitate with the calcium carbonate. Therefore, increasing the amount of dissolved calcium carbonate increases the amount of calcium carbonate that can coprecipitate with the heavy metals. This step is only necessary if the adit water is at saturation or supersaturation with respect to calcium carbonate, or if more aggressive treatment is required to remove high metal concentrations. For example, when hydrochloric acid is used, the reaction is as indicated in Equation 1A:

HCl→H⁺+Cl⁻ (Eq. 1A)

Perferably, the pH is lowered by adding carbon dioxide gas, which more appropriately buffers the water though a bicarbonate buffer system according to the reaction indicated in Equation 1B:

2H₂O+CO₂ [symbol] H₂CO₃+H₂O [symbol] H₃O⁺+HCO₃ (Eq. 1B)

Next, a source of calcium carbonate is added to the water (or treated lower-pH water) to produce a solution of calcium carbonate. The source of calcium carbonate is added under conditions, such as temperature, pressure, and molar ratio, to produce a solution of calcium carbonate. The source of calcium carbonate can be the rocks limestone or dolomite, reagents containing the minerals calcite, aragonite, ankerite, or dolomite, or addition of reagents containing calcium and carbonate or bicarbonate (e.g., sodium bicarbonate). The calcium and carbonate can also come from calcium and carbonate-bearing reagents, such as calcium chloride and sodium bicarbonate. The calcium carbonate source can be added within a tank or reaction vessel, or the water can be passed through a bed of the calcium carbonate-bearing material. The carbon dioxide is not allowed to degas until the solution is separated from the calcium carbonate source to prevent armoring. Armoring is a precipitate (a solid mineral forming on the surface of the limestone) whereas adsorption is when ions are attracted to the surfaces due to electrostatic effects (e.g., positive ions are attracted to a negatively charged surface and vice versa). Thus, in this step, the hydrogen ion from the acid reacts with, for example, solid calcium carbonate as indicated in Equation 2:

2H⁺+CaCO₃→Ca²⁺+CO₂(g)+H₂O(l) (Eq. 2)

After reacting the water with the calcium carbonate, the solution of calcium carbonate is treated to cause coprecipitation of calcium carbonate and the one or more heavy metals. Typically, this is performed by raising the pH, such as by adding base or stripping carbon dioxide from the solution. Carbon dioxide stripping can be performed by bubbling or sparging air through the solution. Active sparging of air can be performed using a diffuser or other device. Passive sparging can be performed using riffles, riprap, serpentine channels, sprayers, a fountain, a venturi device or other structures or processes to strip out carbon dioxide gas by agitating the water and creating conditions favorable to rapid gas exchange. As a result, the solution becomes supersaturated with calcium carbonate, which subsequently precipitates out of solution. When the calcium carbonate precipitates out of solution, the heavy metal or metals coprecipitate with it and can be subsequently separated from the water. Thus, example reactions employing zinc and cadmium as the heavy metals are believed to occur as indicated in Equations 3 and 4:

5Zn²⁺(aq)+Ca²⁺(aq)+3HCO₃⁻(aq)+6H₂O(l)→CaCO₃(s)+9H⁺(aq)+Zn₅(OH)₆(CO₃)₂(s) (Eq. 3)

xCd²⁺(aq)+(1−x)Ca²⁺(aq)+HCO₃⁻(aq)→CdₓCa₁₋ₓCO₃(s)+H⁺(aq) (Eq. 4)

where “x” is the mole fraction of cadmium in the solid formed

As illustrated, some zinc is retained in the calcium carbonate as hydrozincite or similar mineral and cadmium is retained within the calcite structure. Zinc and cadmium can also be removed by adsorption onto the precipitating calcium carbonate phase. Adsorption occurs when a metal, such as zinc, attaches to the surfaces of the precipitating calcite. Adsorption is greatly enhanced by the very fine grain size and high surface area of the calcite during precipitation from solution. Adsorption is distinctly different from using pre-existing calcite as an adsorption media, which even when finely milled or ground does not have nearly as much surface area or adsorption capacity as calcite precipitating from solution.

The steps above can be performed using a variety of different reagents depending on the application (passive vs. active or primary vs. secondary). A passive system is a treatment system that requires little maintenance, while an active system requires operators to add reagents, and other processes within a water treatment facility. For example, calcium chloride and sodium bicarbonate can be used in an active system, while a bed of crushed limestone can be used in a passive system. A primary treatment system is the main removal system for the adit water (or contaminated industrial waste water), while a secondary treatment system is used in conjunction with other treatment systems either as pre-treatment before the primary system or a post-treatment polishing step or both.

### EXEMPLIFICATION

### Example #1: Bench-Scale Testing: Batch Testing

Methods: The limestone batches were prepared using approximately ¼-inch minus limestone obtained from a quarry near Helena, Mont. For Batch 1 (Limestone Only), the limestone was placed in a 1 liter (L) poly bottle along with the adit water at a liquid to solid ratio (L:S) of approximately 2.4:1 by mass and mixed in a rotary tumbler for 24 hours. Batch 2 (Limestone Plus CO₂) was prepared in the same manner except the adit water was supercharged with carbon dioxide using a diffuser prior to preparation of the batch. Following tumbling, the solutions were decanted from the batches into beakers and sparged with air using an aquarium pump until the pH stabilized (approximately pH 8). Onsite laboratory parameters (temperature, pH, oxidation-reduction potential (ORP), dissolved oxygen (DO), and conductivity were measured during sparging. The solution was then filtered through a 0.45 micrometer (μm) membrane and sent to Test America in Denver, Colo. for analysis of dissolved metals and silica (Method SW-846 6010/6020), orthophosphate (EPA Method 365.1), nitrate/nitrite (EPA Method 353.2), chloride (EPA Method 9056), fluoride (EPA Method 9056), sulfate (EPA Method 9056), alkalinity (Standard Methods 2329B), and total dissolved solids (TDS) (EPA Method 160.1).

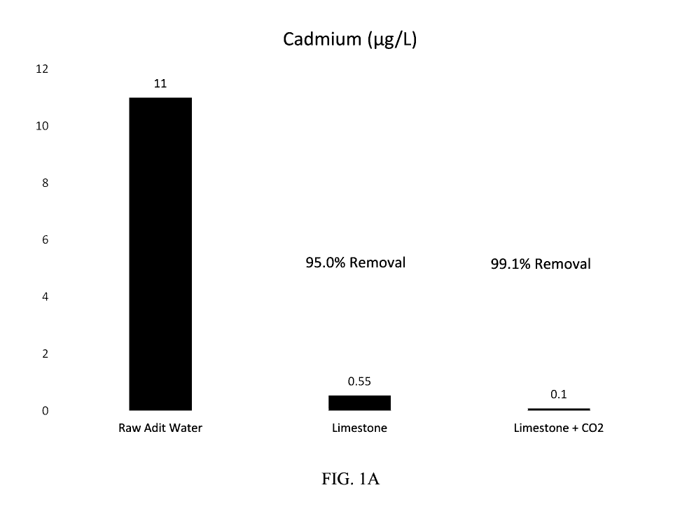

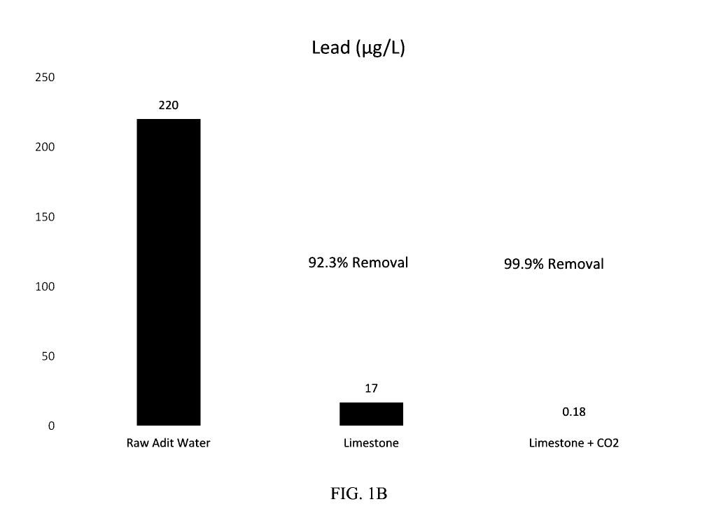

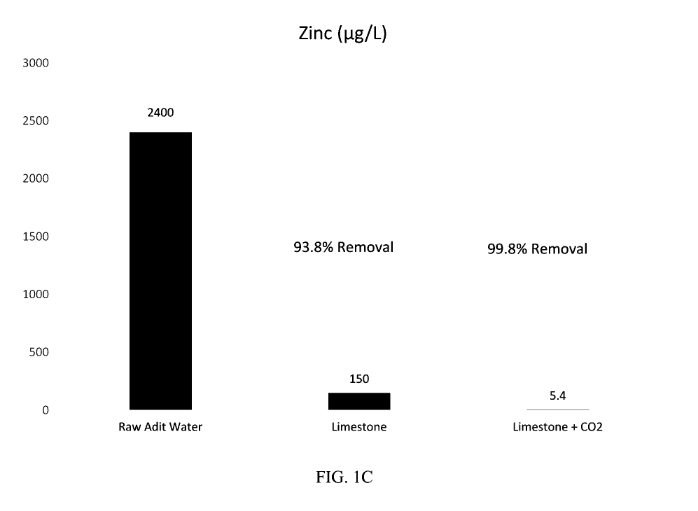

Results: As shown in FIGS. 1A-C, removal ranged from 92.3% to 95.0% for limestone only treatment and greater than 99% for the limestone plus CO₂ treatment for cadmium, lead, and zinc.

### Example #2: Bench-Scale Testing: Column Testing

Methods: Two flow-through column tests were conducted, one with only limestone treatment (C-LMSTN) and the other with CO₂ acidification followed by limestone treatment (C-CO2-LMSTN). Effluent from both treatment column processes were then post-treated by air sparging to strip carbon dioxide. The same analytical methods were used as for the batch tests.

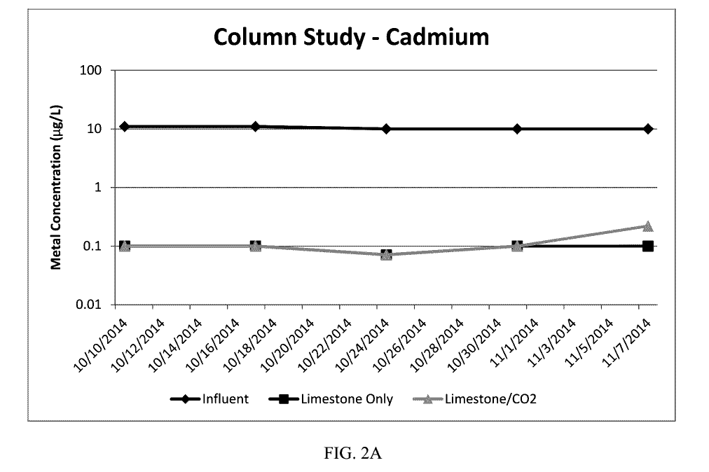

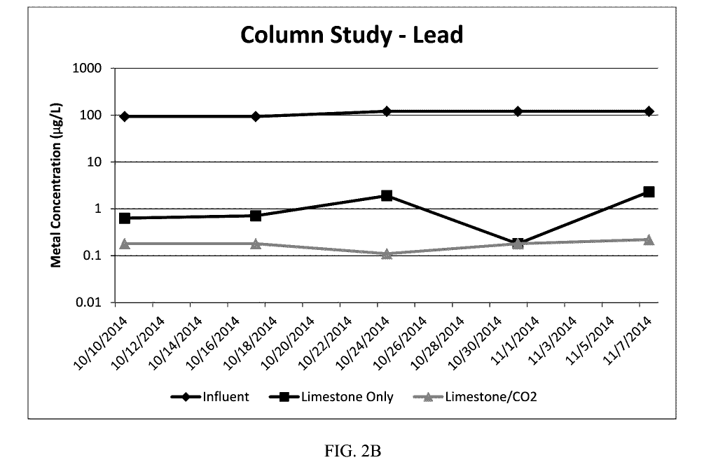

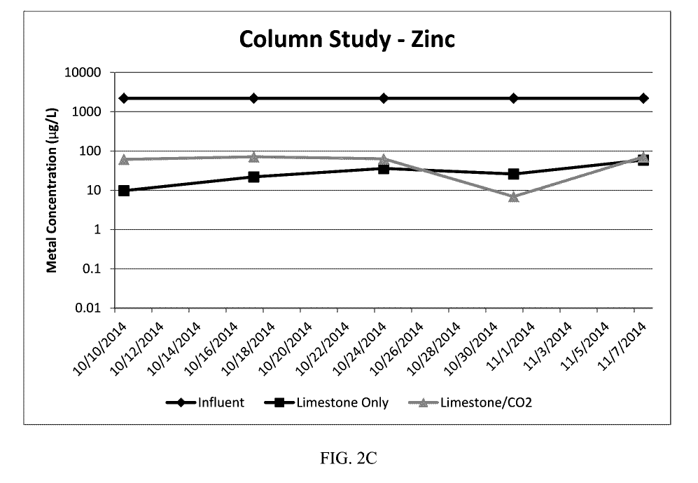

Results: FIGS. 2A-C show the concentration trends over time for cadmium, lead, and zinc within the effluent from the carbon dioxide stripper. Both the limestone only and limestone plus CO₂ columns resulted in 96-99% removal of cadmium, lead, and zinc.

Cadmium concentrations were below the laboratory reporting limit of 0.1 μg/L during all sampling events, with the exception of a value of 0.22 μg/L on Nov. 7, 2014 and 0.27 μg/L on Nov. 14, 2014 (not shown on graph) for the limestone plus CO₂ column.

Lead removals for the limestone plus CO₂ column (0.11-0.22 μg/L) were significantly better than for the limestone only column (0.18-2.3 μg/L).

The removals for the limestone only column were better for zinc during the first two weeks of the test than for the limestone plus CO₂ column (possibly due to adsorption within the column). After about two weeks the zinc concentrations for the limestone only column increased from about 10 μg/L to about 50 μg/L. The effluent from the limestone plus CO₂ column remained fairly stable at 60-70 μg/L zinc over the course of the testing.

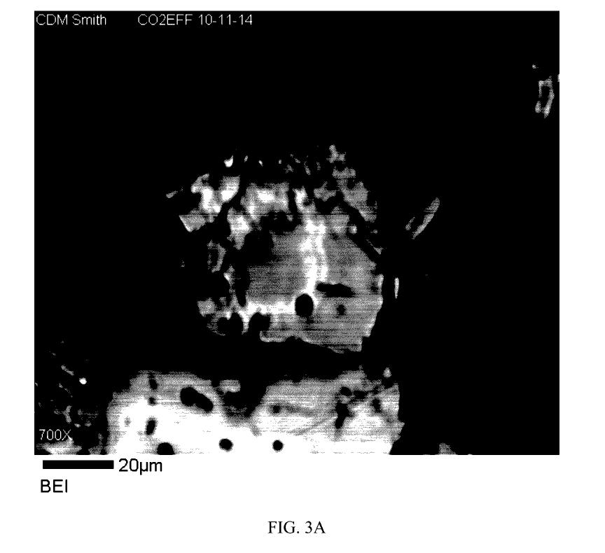

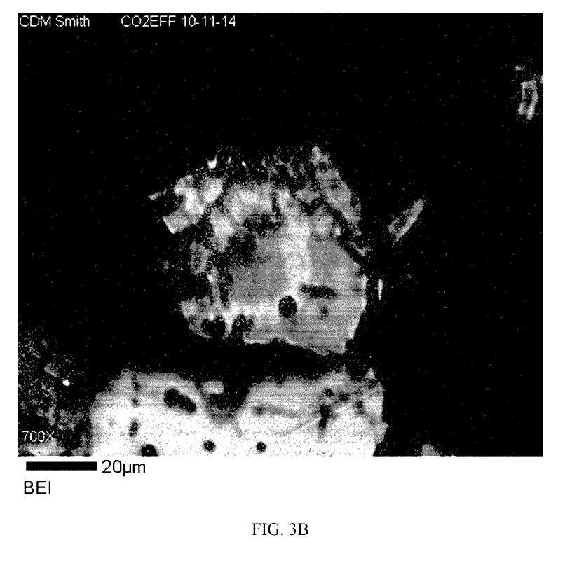

Electron Microprobe (EMP) Results: EMP analyses were performed on the precipitate formed within the air sparging vessel for the limestone plus CO₂ column. The results indicate that the precipitate had a composition consistent with calcite with zinc concentrations from 0.2 to 1.5%. FIGS. 3A and 3B are images from the instrument showing the distribution of zinc within the precipitate.

Bench-Scale Testing: Column Testing: Effect of Carbon Dioxide Stripping

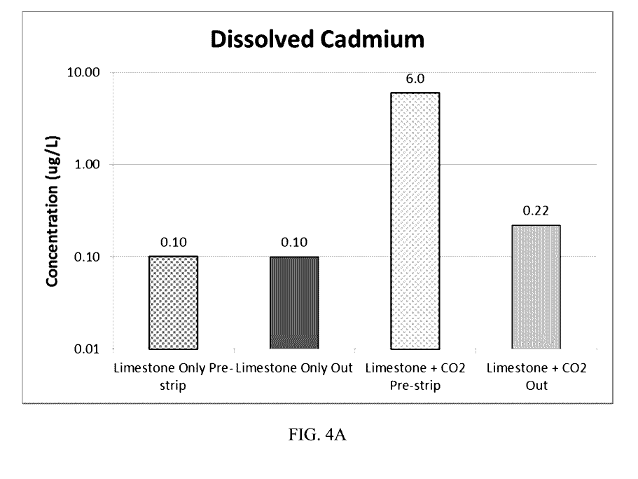

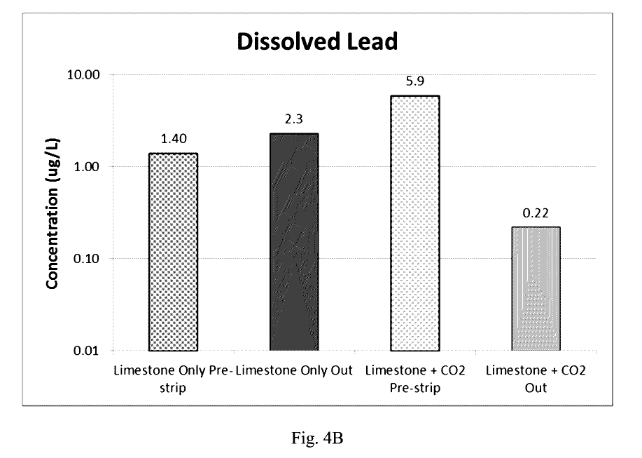

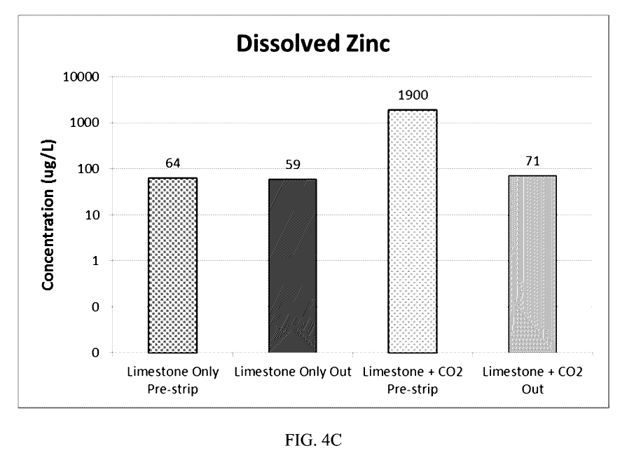

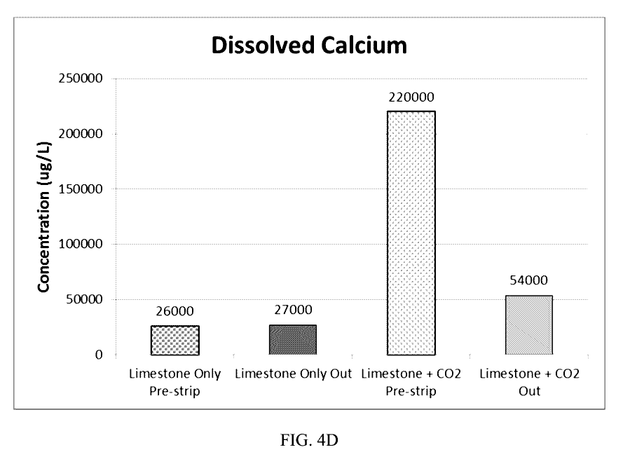

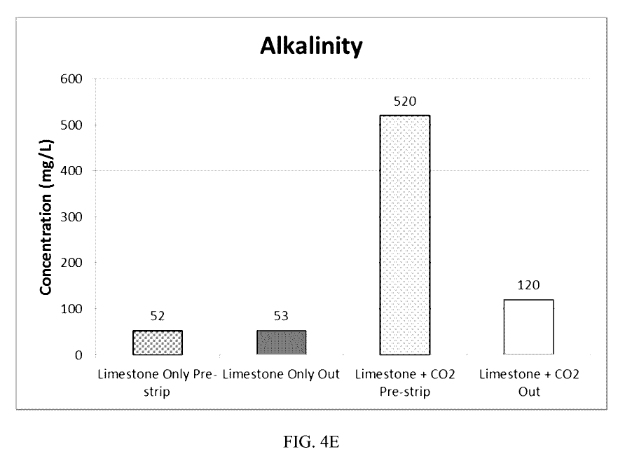

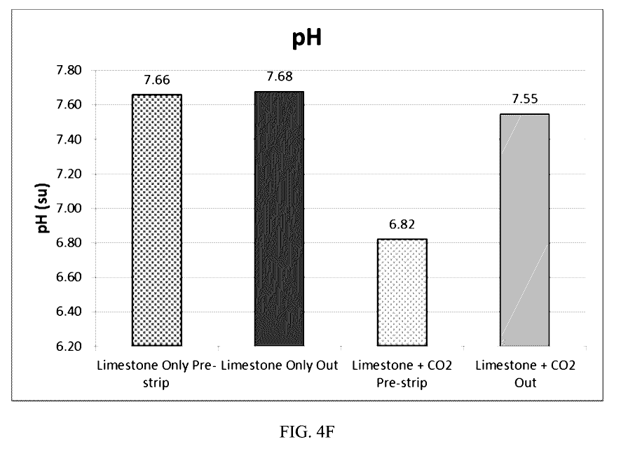

On Nov. 7, 2014, effluent from the limestone only and limestone plus CO₂ columns prior to CO₂ stripping was collected from a port within the effluent tubing for the two columns. The results of the pre-stripping and post-stripping analyses were used to perform a mass balance to determine the effect of the stripping process. The effects of the CO₂ stripping on the cadmium, lead, zinc, and calcium concentrations are presented in FIGS. 4A-F for both columns. The same analytical methods were used as for the batch tests.

Limestone Only Column

The metals concentration were essentially the same both before and after CO₂ stripping as shown in FIGS. 4A-F and Table 1.

TABLE 1
Metals Mass Balance for the Limestone Only Column (No CO2 Acidification)

| | Influent- | Pre-strip- | % Removal | Post-strip | | |
|---|---|---|---|---|---|---|
| | μg/L (Oct. | μg/L (Nov. | From | μg/L | % Removal | Total % |
| Metal | 31, 2014) | 7, 2014) | Influent | (Nov. 7, 2014) | from Stripping | Removal |
| Cadmium | 10 | <0.1 | >99% | <0.1 | 0% | >99% |
| Lead | 120 | 1.4 | 98.8% | 2.3 | 0% | 98.8% |
| Zinc | 2200 | 64 | 97.1% | 59 | 0.2% | 97.3% |

The Ca and alkalinity in the pre-stripping column effluent were only slightly higher than for the influent water (approximately double), indicating minimal limestone dissolution within the column (see Table 2). In addition, the Ca concentrations, bicarbonate alkalinity, and pH were unchanged by the stripping process, which indicates that calcite was not being formed.

TABLE 2
Calcite Mass Balance for the Limestone Only Column

| | | | | Post- | |
|---|---|---|---|---|---|
| | Influent - | Pre-strip - | | strip - | |
| | mg/L | mg/L | Calcite | mg/L | Calcite |
| | (Oct. | (Nov. | Dissolved² | (Nov. 7, | Precipitated¹ |
| Metal | 31, 2014) | 7, 2014) | (mg/L) | 2014) | (mg/L) |
| Calcium | 14 | 26 | 30 mg/L | 27 | 0 mg/L |
| Alkalinity | 24 | 52 | 28 mg/L | 53 | 0 mg/L |
| as CaCO₃ | | | | | |

¹Negative value was assumed to be zero.
²Calculation of the amount of calcite dissolved was based both on the decrease in calcium, and the decrease in alkalinity.

The results show that, in this case, the pH of the original water was too high (7.2 to 7.3) for the process to be effective in the long term. While the results were initially effective, this was due to adsorption of the metals onto the limestone within the column. Once the surfaces of the limestone became fully loaded with metals, the treatment effectiveness declined. The decline in effectiveness for zinc over the course of the column study is shown in FIG. 2C.

Limestone Plus CO₂ Column

A comparison of the metals concentrations within the influent, pre-stripping effluent, and post-stripping effluent is shown in FIGS. 4A-F and Table 3.

TABLE 3
Metals Mass Balance for the Limestone Plus CO₂ Column

| | | Pre-strip- | % of the | Post-strip | % of the | |
|---|---|---|---|---|---|---|
| | Influent- | μg/L | Removal | μg/L | Removal Due to | |
| | μg/L | (Nov. 7, | Due to | (Nov. 7, | Calcite | Total % |
| Metal | (Oct. 31, 2014) | 2014) | Limestone | 2014) | Precipitation | Removal |
| Cadmium | 10 | 6 | 40% | 0.22 | 57.8% | 97.8% |
| Lead | 120 | 5.9 | 95% | 0.22 | 4.8% | 99.8% |
| Zinc | 2200 | 1900 | 13.6% | 71 | 83.2% | 96.8% |

Approximately 40% of the cadmium removal takes place within the column, either as an adsorbed phase or a secondary precipitate on the limestone (possibly near the effluent end of the column where less limestone dissolution is taking place). The majority of the lead was removed within the limestone, either as an adsorbed phase or precipitate. Only 13.6% of the zinc was removed within the column, with the remaining removal (83.2%) taking place during stripping (via calcite precipitation).

The calcite mass balance calculation results are presented in Table 4.

TABLE 4
Calcite Mass Balance for the Limestone Plus CO2 Column

| | | | | Post- | |
|---|---|---|---|---|---|
| | Influent - | Pre-strip - | | strip - | |
| | mg/L | mg/L | Calcite | mg/L | Calcite |
| | (Oct. | (Nov. | Dissolved | (Nov. | Precipitated |
| Metal | 31, 2014) | 7, 2014) | (mg/L) | 7, 2014) | (mg/L) |
| Calcium | 14 | 220 | 515 | 54 | 415 |
| Alkalinity | 24 | 520 | NA¹ | 120 | NA¹ |
| as CaCO3 | | | | | |

¹Not performed using alkalinity because both calcite dissolution/precipitation and the CO₂ addition/stripping affected the change in alkalinity

Approximately 515 mg/L calcite was dissolved within the limestone column (based on the calcium mass balance and the stoichiometry of calcite). During stripping, 415 mg/L calcite was re-precipitated removing 1.8 mg/L Zn with the precipitate. Therefore, the precipitate should have had a concentration of approximately 4,300 mg/kg Zn ((1.8 mg/L/(415 mg/L+1.8 mg/L))*1,000,000 mg/kg=4,300 mg/kg). The EMP analysis of the precipitate within the stripping vessel showed that the material had a composition consistent with calcite and contained 0.2 to 1.5% zinc (2,000 to 15,000 mg/kg) with a median of 0.5% (5,000 mg/kg). Similar calculations for cadmium and lead result in concentrations within the calcite precipitate of 13.9 mg/kg and 13.6 mg/kg, respectively. Cadmium and lead were below the instrument detection limit of the EMP, which were 183 and 310 mg/kg, respectively. Again, the EMP results confirmed the predictions made by the mass balance.

### Example #3

### Procedures

### Sampling Procedures

Phase 1 testing was performed on zinc-spiked deionized water and did not require sampling. For Phase 2, ten-gallons of mining influenced water (MIW) was collected from the Jopes Adit discharge seep on Dec. 2, 2015. Water was collected directly from the seep location where the Jopes Adit water discharges at the surface.

The water was collected from near the bottom of the pool (approximately 1 m deep) directly into the sample containers, which were filled all the way to the top with no headspace or bubbles. Two 5-gallon plastic carboys were filled, tightly sealed, and the lids taped to minimize escape of carbon dioxide during shipment. Field parameters (pH, Oxidation-Reduction potential [ORP], temperature, and dissolved oxygen [DO]) were measured directly within the pool following sample collection.

### Laboratory Procedures

### Phase 1—Initial pH Adjustment on Spiked Reagent Water

Two procedures were performed to evaluate pH adjustment on the removal of metals in spiked deionized (DI) water using calcite precipitation. These tasks are identified as Phase 1a and Phase 1b.

Phase 1a involved testing zinc removal efficiency by adjusting the initial pH of synthetic water (DI water spiked with zinc) with carbon dioxide (CO₂) and hydrochloric acid (HCl) before the addition of limestone. Side by side tests using both HCl and CO₂ were performed using an initial pH value of 5.0. Prior to sparging the samples were analyzed for zinc, calcium and magnesium and following sparging, the samples were analyzed for zinc, calcium, magnesium and alkalinity. The following procedure was followed:

Step 1: A total of 2 liters (L) of 5,000 μg/L zinc-spiked DI water was prepared using zinc sulfate heptahydrate (ZnSO₄.7H₂O), to make a 5,000 μg/L Zn solution.

Step 2: Approximately 550 mL to of the spiked DI water was transferred into two labeled beakers.

Step 3: To beaker 1, CO₂ gas was bubbled through the solution to obtain a pH of approximately 5. This solution was transferred to a 500 mL Nalgene bottle with zero headspace.

Step 4: To beaker 2, the spiked reagent water was adjusted to a pH of 5 with 0.1N HCl. This solution was transferred to a 500 mL Nalgene bottle with zero headspace.

Step 5: Two labelled 1 L Nalgene bottles were prepared by adding a measured quantity of ¼″ washed limestone (about ¾ full).

Step 6: The pH adjusted water was added to each limestone bottle and the bottles were capped lightly to eliminate excessive pressure build up.

Step 7: The bottles were allowed to sit for 1 day before proceeding to step 8.

Step 8: Each bottle was opened and a subsample (approximately 10 mL) was removed to measure pH and temperature.

Step 9: A 100 mL aliquot of each sample was decanted into labelled and preserved (HNO₃) bottles for analysis of Zn, Ca, and Mg.

Step 10: The remaining solution was decanted from each bottle into separated labelled beakers and sparged for approximately 30 minutes using an aquarium stone and pump.

Step 11: The pH and temperature was measured on a subsample from each beaker.

Step 12: Following sparging, a 100 mL aliquot of each sample was decanted into labelled and preserved (HNO₃) bottles for analysis of Zn, Ca, and Mg. An additional 100 mL was decanted into labelled un-preserved bottles for alkalinity analysis.

Phase 1b involved following the same procedures from Phase 1a up to steps 7 and 8. In step 7 the bottles were capped tightly. The cap threads were sealed with Teflon tape and the outside of the cap was sealed with electrical tape in an effort to eliminate CO₂ off gassing. For step 8 the samples were rotated for 18-hours in a rotary tumbler (18 rpm). Steps 9 through 12 were not changed from Phase 1a.

A summary of the analytical methods used is presented in Table 5.

TABLE 5
Analytical parameters

| Parameter | Method | Pre-Sparging | Post-Sparging |
|---|---|---|---|
| Aluminum | SW-846 Method | — | X |
| | 6010/6020 | | |
| Arsenic | SW-846 Method | — | X |
| | 6010-6020 | | |
| Cadmium | SW-846 Method | X | X |
| | 6010/6020 | | |
| Calcium | SW-846 Method | X | X |
| | 6010/6020 | | |
| Copper | SW-846 Method | X | X |
| | 6010/6020 | | |
| Magnesium | SW-846 Method | X | X |
| | 6010/6020 | | |
| Manganese | SW-846 Method | X | X |
| | 6010/6020 | | |
| Nickel | SW-846 Method | X | X |
| | 6010/6020 | | |
| Potassium | SW-846 Method | — | X |
| | 6010/6020 | | |
| Silicon | SW-846 Method | — | X |
| | 6010/6020 | | |
| Sodium | SW-846 Method | — | X |
| | 6010/6020 | | |
| Zinc | SW-846 Method | X | X |
| | 6010/6020 | | |
| Total Alkalinity | SM 2320B | X | X |
| TDS | SM 2540C | — | X |
| Chloride | EPA 300.0 | — | X |
| Orthophosphate | EPA 300.0 | — | X |
| Sulfate | EPA 300.0 | — | X |
| Nitrate + Nitrite | SM4500-NO3—H | — | X |

SW-846: Test Methods for Evaluation of Solid Waste: Physical/Chemical Methods, USEPA
SM: Standard Methods for the Examination of Water and Wastewater, APHA, AWWA, WEF
EPA: Methods for Chemical Analysis of Water and Wastes, USEPA

### Phase 2

Phase 2 was designed to test several different conditions listed below:

Test 1—Type of initial pH adjustment (acid used)—Side by side tests using both HCl and sulfuric acid (H₂SO₄) were performed using four initial pH value (5.3, 5.0, 4.5 and 4.0). The effectiveness (metals removal) was measured both before and after air sparging.

Test 2—Effect of initial pH value on metals removal—Four different initial pH values (5.3, 5.0, 4.5 and 4.0 adjusted with both HCl and H₂SO₄) were tested for individual solutions of the metals listed in Table 2-1. The effectiveness was measured both before and after air sparging.

Test 3—Effects of sulfate on removal—Sulfate at high concentrations could potentially interfere with the treatment. This test simulated metals treatment under four different sulfate concentrations (100, 300, 500 and 700 mg/L) added using sodium sulfate (Na₂SO₄). The initial pH of the solution was adjusted to 4.0 with H₂SO₄ after the addition of the sulfate. The effectiveness of metals removal was measured both before and after air sparging.

Test 4—Manganese Removal—The effectiveness of removing high concentration of manganese was evaluated. Manganese was spiked into the adit water at 5 mg/L using manganese (II) chloride (MnCl₂). The initial pH of the water was adjusted to 5.0 and 4.0 using 0.1N HCl.

Test 5—Control—Seaton Mine/Jopes Adit water subjected to sparging only, no limestone reaction

The following procedures were followed for bench scale testing for Phase 2:

For tests 1 and 2 a total of 1.0 L of Seaton Mine/Jopes Adit water was transferred to a clean 1.2 L glass beaker. The initial pH, ORP, temperature and conductivity were recorded.

For tests 3 and 4 Jopes Adit MIW was transferred to a clean 1 L volumetric flask. The appropriate mass of Na₂SO₄ (test 3) or MnCl₂ (test 4) was added to the flask and the final volume was adjusted to 1.0 L. This solution was then transferred to a 1.2 L glass beaker.

The appropriate acid (0.1N HCl in tests 1 and 4 or 0.1N H₂SO₄) was added volumetrically until the target pH was achieved.

One labelled 1 L Nalgene bottle per solution was prepared by adding a measured quantity of ¼″ washed limestone (the bottle was about ¾ full).

The pH adjusted water was added to the appropriate limestone bottle with zero headspace left. The cap threads were sealed with Teflon tape and the outside of the cap was sealed with electrical tape to minimize CO₂ off gassing.

Each bottle was allowed to sit for two hours with gentle mixing (rocking the bottle) every 30-minutes.

After the 2-hour reaction time, each bottle was opened and a subsample (approximately 25 mL) was removed to measure pH, ORP, conductivity and temperature.

A 150 mL aliquot of each sample was decanted and filtered through a 0.45 μm disk membrane filter into labelled and the appropriate preserved bottles for analysis of parameters in Table 5.

The remaining solution was decanted from each bottle into separated labelled beakers and sparged for approximately 30 minutes using an aquarium stone and pump.

The pH, ORP, conductivity and temperature were measured on a subsample from each beaker.

Following sparging a 300 mL aliquot of each sample was decanted and filtered through a 0.45 μm disk membrane filter directly into labelled and appropriately preserved bottles for analysis of parameters in Table 5.

The precipitate produced during the aeration procedure was collected on 0.45 μm filter disks and archived for potential electron microprobe analysis in the future.

Analytical testing was performed at RTI Laboratories in Livonia, Mich. USA for the parameters and methods identified in Table 5.

### Data Analysis

### PHREEQC Modeling

Modeling of the adit water was performed using the USGS model PHREEQC (Parkhurst and Appelo, 2013). PHREEQC is an equilibrium speciation model that takes into account ionic complexing, activity effects, and the temperature and pressure conditions of the water being modeled to predict the saturation state of various minerals. Evaluations of the saturation state of the waters are performed by the model using the solubility product constants (Kₛₚ). For example, for the mineral calcite the expression for the solubility product constant is as follows:

[Ca⁺²][CO₃⁻²]=10^{-8.47}=Kₛₚ (Eq. 5)

The square brackets denote activities (in units of moles/L). If the product of the calcium and carbonate in the solution exceed the Ksp value, then calcite is predicted to precipitate from solution. The PHREEQC model performs the solubility calculations as follows:

Ionic complexes are calculated using ion activity constants.

Activity coefficients are calculated from the ionic strength of the solution (I) using the Davies Equation.

Equilibrium with atmospheric CO₂ partial pressures are calculated using the pH and alkalinity of the solution.

### Ionic Complexes

In solution, negatively and positively charged ions associate with each other to form aqueous complexes. For example, a positively charged calcium ion (Ca⁺²) tends to be attracted to a negatively charged ion such as (OH⁻), such that the two ions exist in solution adjacent to each other and act as a unit (denoted as CaOH⁻). The importance of complexing is that the species such as CaOH⁻ do not take part in the reaction to form calcite. All of the calcium tied up in these aqueous complexes is not available for reaction. Other aqueous complexes also form with carbonate, such as the bicarbonate ion (HCO₃⁻). The degree to which each complex forms is based on thermodynamic data determined through experimentation, which are called complexation constants (K). An example for bicarbonate ion is as follows:

CO₃⁻²(aq)+H⁺→HCO₃⁻K=10^{-10.3} (Eq. 6)

The complexation constants within the PHREEQC database are used to calculate all of the species of calcium and carbonate, which are subtracted from the total concentrations to obtain the species (CO₃⁻² and Ca⁺²) used in the solubility product constant (Kₛₚ) expression.

### Activity Coefficients

In a solution of ions, the polar water molecules interact with charged species, such that some of the water associates with the ions. In addition the charged ions interact with each other. To account for these interactions, the activities of species are used rather than the concentrations. Activities are calculated using activity coefficents as follows:

(Ca⁺²)γCa⁺²=[Ca⁺²] (Eq. 7)

Where γCa⁺² is the activity coefficient for Ca⁺² and [Ca⁺²] is the activity of Ca⁺². Activity coefficients are calculated within PHREEQC using a parameter known as the ionic strength (I) of the solution. The ionic strength is a measure of the quantity of ions in solution and is given by the following:

I=½Σcᵢzᵢ² (Eq. 8)

Where cᵢ is the concentration of ion “i” in moles/L and zᵢ is the charge on ion i. When I is less than 0.5, the Davies Equation can be used to calculate the activity coefficient as follows (for ion i):

Log γᵢ=−(A*zᵢ²*(I)^{1/2}/[1+B*aᵢ⁰*(I)^{1/2}])+bi*I (Eq. 9)

Where A, B, a, and b are constants for a given ion. These constants are reported in the literature and are included within the PHREEQC database.

### Input Parameters

Modeling was performed only for the Phase 2 testing due to the limited analyses performed for Phase 1 (not all required parameters for modeling were analyzed). The input parameters used in the PHREEQC model for the Phase 2 tests are presented in Tables 3-4 through 3-8 (below). Modeling was not performed unless a complete analysis was available or when the missing analytes could be reasonably assumed to be unchanged from the control analysis.

### Internal Consistency Analysis

The laboratory analyses were checked for internal consistency using both charge balance and mass balance relationships. The charge balance was calculated as follows:

[Σ(Cations×charge)−Σ(Anions×charge)]/[Σ(Cations×charge)+Σ(Anions×charge)]*100% (Eq. 10)

Where “cations” refers to the molar concentration of positively charged ions (millimoles/L) and “anions” to the molar concentration of negatively charged ions.

The mass balance was calculated using the following relationship:

(TDSCalculated−TDSMeasured)/TDSMeasured×100% (Eq. 11)

TDS was calculated by summing the concentrations of all species in mg/L. Adjustments were made in cases where the species that would be formed upon evaporation was in a different form than that provided by the laboratory. For instance, silicon reported as “Si” (atomic mass=28.09 g/mole) would be converted to “SiO2” (atomic mass=60.09 g/mole) using the factor 2.14 (60.09 g/mole/28.09 g/mole=2.14). In addition, the bicarbonate concentration was multiplied by a factor of 0.49 to account for loss of carbon dioxide gas during evaporation.

By evaluating both the mass balance and charge balance, conclusions could be made about the accuracy and completeness of the analysis. The possible mass balance and charge balance combinations and the corresponding interpretations are shown in Table 6 and results are shown in Table 7.

TABLE 6
Interpretation of Charge and Mass Balance Results

| Mass Balance | Charge Balance | Interpretation 1 |
|---|---|---|
| Positive | Positive | Cations are over-reported |
| Positive | Negative | Anions are over-reported |
| Negative | Negative | Cations are under-reported |
| | | and/or one or more important |
| | | cations were not analyzed |
| Negative | Positive | Anions are under-reported |
| | | and/or one or more important |
| | | anions were not analyzed |

Note:
The interpretation represents the least complex explanation. In some cases, multiple problems with an analysis may have caused the inconsistencies.

TABLE 7
Interpretation of Charge and Mass Balance Results

| | Measured | Calculated | | | | Charge | |
|---|---|---|---|---|---|---|---|
| | TDS | TDS | Mass Balance | ΣCations | ΣAnions | Balance | |
| Sample | (mg/L) | (mg/L) | (%) | (mmoles) | (mmoles) | (%) | Conclusion |
| Test 0 | 57 | 76 | −24.4 | 0.9 | 0.9 | 2.1 | Missing |
| | | | | | | | anions |
| Test 1a- | 144 | — | N/A | 2.8 | 2.6 | 3.5 | N/A |
| Pre | | | | | | | |
| Test 1a- | 159 | 180 | −11.6 | 2.9 | 2.9 | −0.1 | Missing |
| Post | | | | | | | cations |
| Test 1b- | 153 | — | N/A | 2.9 | 2.7 | 2.9 | N/A |
| Pre | | | | | | | |
| Test 1b- | 162 | 180 | −10.2 | 3.1 | 2.8 | 5.0 | Missing |
| Post | | | | | | | anions |
| Test 1c- | 156 | — | N/A | 3.1 | 2.7 | 5.5 | N/A |
| Pre | | | | | | | |
| Test 1c- | 175 | 190 | −8.1 | 3.3 | 3.1 | 3.1 | Missing |
| Post | | | | | | | anions |
| Test | 163 | — | N/A | 3.1 | 2.9 | 2.9 | N/A |
| 1d-Pre | | | | | | | |
| Test | 176 | 200 | −12.2 | 3.4 | 3.1 | 3.8 | Missing |
| 1d-Post | | | | | | | anions |
| Test | 163 | — | N/A | 3.1 | 2.9 | 3.2 | N/A |
| 2a-Pre | | | | | | | |
| Test | 174 | 190 | −8.2 | 3.3 | 3.1 | −4.7 | Missing |
| 2a-Post | | | | | | | anions |
| Test | 183 | — | N/A | 3.2 | 3.5 | 3.2 | N/A |
| 2b-Pre | | | | | | | |
| Test | 172 | 200 | −14.0 | 3.3 | 3.1 | 3.2 | Missing |
| 2b-Post | | | | | | | anions |
| Test | 151 | — | N/A | 2.8 | 2.8 | 0.0 | N/A |
| 2c-Pre*** | | | | | | | |
| Test | 160 | 170 | −6.0 | 3.0 | 2.9 | 1.4 | Missing |
| 2c-Post | | | | | | | anions |
| Test | 157 | — | N/A | 3.1 | 2.7 | 6.3 | N/A |
| 2d-Pre | | | | | | | |
| Test | 180 | 200 | −10.2 | 3.3 | 3.2 | 1.2 | Missing |
| 2d-Post | | | | | | | anions |
| Test | 325 | — | N/A | 5.3 | 5.3 | 0.5 | N/A |
| 3a-Pre* | | | | | | | |
| Test | 342 | 340 | 0.5 | 5.5 | 5.5 | −0.1 | Too many |
| 3a-Post** | | | | | | | anions |
| Test | 625 | — | N/A | 9.3 | 9.8 | −2.6 | N/A |
| 3b-Pre* | | | | | | | |
| Test | 682 | 650 | 5.0 | 9.5 | 10.7 | −5.9 | Too many |
| 3b-Post | | | | | | | anions |
| Test | 932 | — | N/A | 13.7 | 14.0 | −2.8 | N/A |
| 3c-Pre* | | | | | | | |
| Test | 945 | 910 | 3.8 | 13.4 | 14.2 | −2.8 | Too many |
| 3c-Post | | | | | | | anions |
| Test | 1238 | — | N/A | 17.0 | 18.8 | −5.1 | N/A |
| 3d-Pre* | | | | | | | |
| Test | 1263 | 1200 | 5.2 | 17.1 | 19.3 | −5.8 | Too many |
| 3d-Post | | | | | | | anions |
| Test | 162 | — | N/A | 3.0 | 2.9 | 2.1 | N/A |
| 4a-Pre | | | | | | | |
| Test | 177 | 190 | −6.9 | 3.3 | 3.2 | 1.6 | Missing |
| 4a-Post | | | | | | | anions |
| Test | 170 | — | N/A | 3.3 | 3.0 | 3.9 | N/A |
| 4b-Pre | | | | | | | |
| Test | 173 | 210 | −17.5 | 3.4 | 3.0 | 5.0 | Missing |
| 4b-Post | | | | | | | anions |

*Sodium concentration set to the value for post sparging
**Sodium increased from 5.7 mg/L to 57 mg/L due to likely reporting error
***Alkalinity decreased from 160 mg/L to 102 mg/L to attain charge balance

For the samples with sodium sulfate added (Test 3) in which sodium was not analyzed (Pre-sparging samples), the sodium value for the post sparging analyses were used. Sodium was unlikely to have changed due to sparging. For one sample (Test 3a-Post), sodium was adjusted from the laboratory-reported value of 5.7 mg/L to 57 mg/L. The value of 5.7 mg/L was likely a reporting error, because 300 mg/L sulfate was added in the form of sodium sulfate, which would have added much more than 5.7 mg/L sodium. The alkalinity for sample Test 2c-Pre was reported as 160 mg/L, which was about 60% higher than for all other samples, (approximately 100 mg/L). When the alkalinity was decreased from 160 mg/L to 101.5 mg/L, the charge balance was improved from −17.4% to zero. The mean organic carbon value for the Jopes Adit was used (0.32 mg/L) for the internal consistency analysis.

The acceptability criteria for internal consistency is ±10% for both the charge balance and the mass balance. Following the adjustments outlined above, all 29 analyses were within the accepted range for charge balance and 22 of 29 analyses were acceptable for mass balance. When the charge balance is consistently within the accepatable limits, but the mass balance is in error, a neutral species such as silica (H₄SiO₄⁰) or dissolved organic carbon is likely either under-reported or not analyzed. In this case, silica is reported along with dissolved organic carbon, and the values are very consistent over time and for the treatability testing. In this case, the mass balances which were outside of the acceptability criteria were for samples which had relatively low TDS. The poor mass balance results were likely due to inaccuracies in the measured TDS values. For samples with low TDS, a small absolute inaccuracy in the value makes a much bigger difference in percentage terms than for a large TDS value. Given that the charge balance criteria were consistently met, and the sometimes poor mass balance does not appear to be related to the analyses of the individual constituents, the data appear to be suitable for modeling purposes.

### Results

### Phase 1 Results

Table 8 presents results for Phase 1a and Table 9 presents results for Phase 1b.

TABLE 8
Results Phase 1a - Limestone Reaction Vessel not Tumbled

| | | Sample ID | | | |
|---|---|---|---|---|---|
| | | | R&D CO₂ | | R&D HCl |
| Parameter | Unit | R&D CO₂ | Sparged | R&D HCl | Sparged |
| Calcium | μg/L | 110,000 | 110,000 | 23,000 | 24,000 |
| Mag- | μg/L | 5,300 | 5,300 | 2,600 | 2,600 |
| nesium | | | | | |
| Zinc | μg/L | 620 | 610 | 75 | 84 |
| Alkalinity | μg/L | — | 190 | — | 29 |
| Beginning | SU | 6.73 | 6.73 | 6.73 | 6.73 |
| pH | | | | | |
| Ending pH | SU | 4.63 | 7.95 | 4.62 | 8.12 |
| Tempera- | ° C. | 19.3 | 19.2 | 19.3 | 19.1 |
| ture | | | | | |
| HCl | ml | — | — | 0.41 | — |
| (0.1N) | | | | | |
| Added | | | | | |
| Aeration | minutes | — | 30 | — | 30 |
| Time | | | | | |

TABLE 9
Results Task 1b - Limestone Reaction Vessel Tumbled

| | | Sample ID | | | |
|---|---|---|---|---|---|
| | | | R&D CO₂ | | R&D HCl |
| Parameter | Unit | R&D CO₂-2 | Sparged-2 | R&D HCl-2 | Sparged-2 |
| Calcium | μg/L | 68,000 | 45,000 | 22,000 | 23,000 |
| Mag- | μg/L | 12,000 | 11,000 | 3,600 | 3,700 |
| nesium | | | | | |
| Zinc | μg/L | 37 | 2.4 | 10 | 4 |
| Alkalinity | μg/L | — | 200 | — | 26 |
| Beginning | SU | 6.73 | 6.73 | 6.73 | 6.73 |
| pH | | | | | |
| Ending pH | SU | 4.63 | 7.95 | 4.62 | 8.12 |
| Tempera- | ° C. | 19.1 | 19.2 | 19.3 | 19.1 |
| ture | | | | | |
| HCL | ml | — | — | 0.41 | — |
| (0.1N) | | | | | |
| Added | | | | | |
| Sparging | minutes | — | 30 | — | 30 |
| Time | | | | | |

The results for the Phase 1a tests showed that little or no calcite precipitation was occurring during the carbon dioxide sparging step for either the carbon dioxide or hydrochloric acid systems. The cause was thought to be escape of carbon dioxide gas from the bottles during the 24 hour tumbling period. The test was repeated without the tumbling step, but the gas was still probably escaping from the bottles. Given the very fast reaction time between calcite and the water, the test procedure for phase 2 was modified from a 24-hour reaction time to 2-hours for Phase 2.

Despite the apparent carbon dioxide loss within the bottles, zinc removal was still about 90% ([5000−620]/5000*100%=87.6%) for the carbon dioxide system and 99% ([5000−75]/5000*100%=98.5%) for the hydrochloric acid system.

### Phase 2 Results—Bench Scale Testing on MIW

A comparison of the parameters collected in the field on Dec. 2, 2015 and those collected at the time of receipt of the sample in CDM Smith laboratory on Dec. 5, 2015 are shown in Table 10. Historical pH measurements for the Jopes Adit MIW averages 5.3 and ranges from 5.0 to 5.5. Apparently the locations of these measurements were at the surface of the seeps. The pH value of 3.49 was measured at a depth of approximately 1 m below the surface (see wire holding the probe in FIG. 2-1). The pH of the adit water likely increased between the seep at depth and the routine sampling stations. In this case, the pH difference between the field and the CDM Smith laboratory could be due to carbon dioxide degassing during shipment of the samples. However, fairly stringent sampling procedures were followed to minimize carbon dioxide loss (i.e. no headspace in containers, tape over container lids, etc.).

TABLE 10
Seaton Mine/Jopes Adit Field Parameters

| | | Field Result | |
|---|---|---|---|
| Parameter | Unit | Dec. 2, 2015 | Result Dec. 4, 2015 |
| pH | SU | 3.49 | 5.51* |
| ORP | Mv | 333.6 | 278 |
| Dissolved Oxygen | Mg/L | 3.78 | — |
| Conductivity | mS/CM | 0.105 | 0.261 |
| Temperature | ° C. | 12.53 | 14 |

*6.98 following sparging

The results for each of the phase 2 tests is presented in the following sections.

### Phase 2—Test 1

A summary of the Phase 2—Test 1 analytical laboratory results using pH adjustment to 5.3, 5.0, 4.5, and 4.0 are presented in Table 11.

TABLE 11
pH Adjustments Using 0.1N HCl

| | | | Concentration | | | Percent Removal | | |
|---|---|---|---|---|---|---|---|---|
| | | | | Pre- | Post- | Pre- | Post- | |
| Test | Parameter | Units | Initial | Sparging | Sparging | Sparging | Sparging | Total |
| pH5.3 | pH | SU | 5.30 | 7.67 | 8.21 | — | — | — |
| | Calcium | μg/L | 6100 | 42000 | 42000 | — | 0.0% | 0.0% |
| | Copper | μg/L | 930 | 93 J | 68 | 90.0% | 2.7% | 92.7% |
| | Magnesium | μg/L | 2100 | 3000 | 2900 | — | — | — |
| | Manganese | μg/L | 140 | — | 52 | — | — | 62.9% |
| | Zinc | μg/L | 530 | 110 | 78 | 79.2% | 6.0% | 85.3% |
| | Total Alkalinity | mg/L | 7 | 91 | 98 | — | — | — |
| | | CaCO₃ | | | | | | |
| pH 5.0 | pH | SU | 5.00 | 7.73 | 8.11 | — | — | — |
| | Calcium | μg/L | 6100 | 45000 | 49000 | — | 0.0% | 0.0% |
| | Copper | μg/L | 930 | 150 | 120 | 83.9% | 3.2% | 87.1% |
| | Magnesium | μg/L | 2100 | 3000 | 3200 | — | — | — |
| | Manganese | μg/L | 140 | — | 69 | — | — | 50.7% |
| | Zinc | μg/L | 530 | 190 | 150 | 64.2% | 7.5% | 71.7% |
| | Total Alkalinity | mg/L | 7 | 100 | 100 | — | — | — |
| | | CaCO₃ | | | | | | |
| pH 4.5 | pH | SU | 4.50 | 7.49 | 8.1 | — | — | — |
| | Calcium | μg/L | 6100 | 48000 | 52000 | — | 0.0% | 0.0% |
| | Copper | μg/L | 930 | 120 | 92 | 87.1% | 3.0% | 90.1% |
| | Magnesium | μg/L | 2100 | 3100 | 3400 | — | — | — |
| | Manganese | μg/L | 140 | — | 53 | — | — | 62.1% |
| | Zinc | μg/L | 530 | 140 | 92 | 73.6% | 9.1% | 82.6% |
| | Total Alkalinity | mg/L | 7 | 100 | 110 | — | — | — |
| | | CaCO₃ | | | | | | |
| pH 4.0 | pH | SU | 4.00 | 7.63 | 8.1 | — | — | — |
| | Calcium | μg/L | 6100 | 49000 | 53000 | — | 0.0% | 0.0% |
| | Copper | μg/L | 930 | 83 J | 72 | 91.1% | 1.2% | 92.3% |
| | Magnesium | μg/L | 2100 | 3200 | 3400 | — | — | — |
| | Manganese | μg/L | 140 | — | 51 | — | — | 63.6% |
| | Zinc | μg/L | 530 | 120 | 84 | 77.4% | 6.8% | 84.2% |
| | Total Alkalinity | mg/L | 7 | 110 | 110 | — | — | — |
| | | CaCO₃ | | | | | | |

Note-
“J” qualifier indicates that the value was below the analytical reporting limit but above the instrument detection limit.
“—” indicates the parameter was not analyzed.

The removal percentages of copper ranged from 87.1% for pH 5.0 to 92.7% for pH 5.3. Little difference or correlation existed between the initial pH and the percentage of copper removed from solution. Similar results were obtained for zinc, with removals ranging from 71.7% at pH 5.0 to 85.3% at pH 5.3. Most of the removal for both metals occurred within the batches as opposed to during sparging. Similar to the Phase 1 tests, calcite did not precipitate during sparging, as evidenced by the constant concentrations of calcium and alkalinity values for the pre-sparging and post-sparging samples. The reasons for the lack of calcite precipitation will be discussed after the PHREEQC modeling results are presented in the next section.

### Phase 2—Test 2—pH Adjustment Using Sulfuric Acid to pH, 5.3, 5.0, 4.5, and 4.0

The results for the Phase 2—Test 2 testing are presented in Table 12.

TABLE 12
pH Adjustments Using 0.1N H₂SO₄

| | | | Concentration | | | Percent Removal | | |
|---|---|---|---|---|---|---|---|---|
| | | | | Pre- | Post- | Pre- | Post- | |
| Test | Parameter | Units | Initial | Sparging | Sparging | Sparging | Sparging | Total |
| pH 5.3 | pH | SU | 5.30 | 7.69 | 8.14 | — | — | — |
| | Calcium | μg/L | 6100 | 49000 | 51000 | — | 0.0% | 0.0% |
| | Copper | μg/L | 930 | 67 J | 67 | 92.8% | 2.7% | 92.8% |
| | Magnesium | μg/L | 2100 | 3500 | 3600 | — | — | — |
| | Manganese | μg/L | 140 | — | 54 | — | — | 61.4% |
| | Zinc | μg/L | 530 | 89 J | 76 | 83.2% | 2.5% | 85.7% |
| | Total Alkalinity | mg/L | 7 | 110 | 110 | — | — | — |
| | | CaCO₃ | | | | | | |
| pH 5.0 | pH | SU | 5.00 | 7.69 | 8.12 | — | — | — |
| | Calcium | μg/L | 6100 | 50000 | 51000 | — | 0.0% | 0.0% |
| | Copper | μg/L | 930 | 61 J | 45 | 93.4% | 1.7% | 95.2% |
| | Magnesium | μg/L | 2100 | 3600 | 3700 | — | — | — |
| | Manganese | μg/L | 140 | — | 41 | — | — | 70.7% |
| | Zinc | μg/L | 530 | 96 J | 51 | 81.9% | 8.5% | 90.4% |
| | Total Alkalinity | mg/L | 7 | 140 | 110 | — | — | — |
| | | CaCO₃ | | | | | | |
| pH 4.5 | pH | SU | 4.50 | 7.35 | 8 | — | — | — |
| | Calcium | μg/L | 6100 | 43000 | 46000 | — | 0.0% | 0.0% |
| | Copper | μg/L | 930 | 210 | 120 | 77.4% | 9.7% | 87.1% |
| | Magnesium | μg/L | 2100 | 2600 | 2900 | — | — | — |
| | Manganese | μg/L | 140 | — | 75 | — | — | 46.4% |
| | Zinc | μg/L | 530 | 240 | 160 | 54.7% | 15.1% | 69.8% |
| | Total Alkalinity | mg/L | 7 | 160 | 99 | — | — | — |
| | | CaCO₃ | | | | | | |
| pH 4.0 | pH | SU | 4.00 | 7.59 | 8.13 | — | — | — |
| | Calcium | μg/L | 6100 | 49000 | 52000 | — | 0.0% | 0.0% |
| | Copper | μg/L | 930 | 90 J | 59 | 90.3% | 3.3% | 93.7% |
| | Magnesium | μg/L | 2100 | 3100 | 3400 | — | — | — |
| | Manganese | μg/L | 140 | — | 42 | — | — | 70.0% |
| | Zinc | μg/L | 530 | 150 | 65 | 71.7% | 16.0% | 87.7% |
| | Total Alkalinity | mg/L | 7 | 100 | 110 | — | — | — |
| | | CaCO₃ | | | | | | |

Note-
“J” qualifier indicates that the value was below the analytical reporting limit but above the instrument detection limit.
“—” indicates the parameter was not analyzed.

The results are similar to the pH adjustment using HCl in that little or no calcite precipitated during the sparging and most of the copper and zinc removal took place within the limestone batches. The copper zinc and manganese removal for the pH 5.3 and 5.0 tests were slightly better than for the HCl additions, while the pH 4.5 and 4.0 were not quite as good as for the HCl additions.

### Phase 2—Test 3—pH Adjustment Using Sulfuric Acid to pH 4.0, Sulfate Addition

The results of the sulfate addition tests are shown in Table 13.

TABLE 13
Sulfate Additions

| | | | Concentration | | | Percent Removal | | |
|---|---|---|---|---|---|---|---|---|
| | | | | Pre- | Post- | Pre- | Post- | |
| Test | Parameter | Units | Initial | Sparging | Sparging | Sparging | Sparging | Total |
| Sulfate | pH | SU | 4.00 | 7.7 | 8.27 | — | — | — |
| 100 | Calcium | μg/L | 6100 | 50000 | 54000 | — | 0.0% | 0.0% |
| mg/L | Copper | μg/L | 930 | 100 | 86 | 89.2% | 1.5% | 90.8% |
| | Magnesium | μg/L | 2100 | 3400 | 3500 | — | — | — |
| | Manganese | μg/L | 140 | — | 45 | — | — | 67.9% |
| | Zinc | μg/L | 530 | 96 | 41 | 81.9% | 10.4% | 92.3% |
| | Total Alkalinity | mg/L | 7 | 110 | 110 | — | — | — |
| | | CaCO₃ | | | | | | |
| | Sulfate | mg/L | 120 | 130 | 140 | — | — | — |
| Sulfate | pH | SU | 4.00 | 7.92 | 8.24 | — | — | — |
| 300 | Calcium | μg/L | 6100 | 49000 | 53000 | — | 0.0% | 0.0% |
| mg/L | Copper | μg/L | 930 | 57 | 54 | 93.9% | 0.3% | 94.2% |
| | Magnesium | μg/L | 2100 | 3600 | 3600 | — | — | — |
| | Manganese | μg/L | 140 | — | 37 | — | — | 73.6% |
| | Zinc | μg/L | 530 | 80 | 39 | 84.9% | 7.7% | 92.6% |
| | Total Alkalinity | mg/L | 7 | 110 | 110 | — | — | — |
| | | CaCO₃ | | | | | | |
| | Sulfate | mg/L | 320 | 320 | 390 | — | — | — |
| Sulfate | pH | SU | 4.00 | 7.98 | 8.29 | — | — | — |
| 500 | Calcium | μg/L | 6100 | 57000 | 54000 | — | 0.0% | 0.0% |
| mg/L | Copper | μg/L | 930 | 50 | 53 | 94.6% | 0.3% | 94.3% |
| | Magnesium | μg/L | 2100 | 3700 | 3800 | — | — | — |
| | Manganese | μg/L | 140 | — | 41 | — | — | 70.7% |
| | Zinc | μg/L | 530 | 61 | 44 | 88.5% | 3.2% | 91.7% |
| | Total Alkalinity | mg/L | 7 | 120 | 110 | — | — | — |
| | | CaCO₃ | | | | | | |
| | Sulfate | mg/L | 520 | 540 | 570 | — | — | — |
| Sulfate | pH | SU | 4.00 | 8.03 | 8.24 | — | — | — |
| 700 | Calcium | μg/L | 6100 | 53000 | 57000 | — | 0.0% | 0.0% |
| mg/L | Copper | μg/L | 930 | 45 | 45 | 95.2% | 0.0% | 95.2% |
| | Magnesium | μg/L | 2100 | 4000 | 3900 | — | — | — |
| | Manganese | μg/L | 140 | — | 28 | — | — | 80.0% |
| | Zinc | μg/L | 530 | 38 | 36 | 92.8% | 0.4% | 93.2% |
| | Total Alkalinity | mg/L | 7 | 120 | 120 | — | — | — |
| | | CaCO₃ | | | | | | |
| | Sulfate | mg/L | 720 | 770 | 790 | — | — | — |

Note-
“J” qualifier indicates that the value was below the analytical reporting limit but above the instrument detection limit.
“—” indicates the parameter was not analyzed.

The addition of sulfate does not appear to affect the metals removal effectiveness. The results are similar to Tests 1 and 2.

Phase 2—Test 4—pH Adjustment Using Hydrochloric Acid to pH 4.0 and 5.0, Manganese Addition (5 mg/L)

The results of the manganese addition tests are shown in Table 14.

TABLE 14
Manganese Removal

| | | | Concentration | | | Percent Removal | | |
|---|---|---|---|---|---|---|---|---|
| | | | | Pre- | Post- | Pre- | Post- | |
| Test | Parameter | Units | Initial | Sparging | Sparging | Sparging | Sparging | Total |
| Manganese 5 | pH | SU | 5.00 | 7.68 | 8.21 | — | — | — |
| mg/L, | Calcium | μg/L | 6100 | 46000 | 50000 | — | 0.0% | 0.0% |
| pH 5.0 | Copper | μg/L | 930 | 51 | 51 | 94.5% | 0.0% | 94.5% |
| | Magnesium | μg/L | 2100 | 3600 | 3700 | — | — | — |
| | Manganese | μg/L | 5000 | 1200 | 1000 | — | — | 80.0% |
| | Zinc | μg/L | 530 | 59 | 42 | 88.9% | 3.2% | 92.1% |
| | Total Alkalinity | mg/L | 7 | 100 | 100 | — | — | — |
| | | CaCO₃ | | | | | | |
| Manganese 5 | pH | SU | 4.00 | 7.7 | 8.21 | — | — | — |
| mg/L, | Calcium | μg/L | 6100 | 50000 | 51000 | — | 0.0% | 0.0% |
| pH 4.0 | Copper | μg/L | 930 | 48 | 46 | 94.8% | 0.2% | 95.1% |
| | Magnesium | μg/L | 2100 | 4000 | 3900 | — | — | — |
| | Manganese | μg/L | 5000 | 1200 | 1000 | — | — | 80.0% |
| | Zinc | μg/L | 530 | 55 | 38 | 89.6% | 3.2% | 92.8% |
| | Total Alkalinity | mg/L | 7 | 100 | 97 | — | — | — |
| | | CaCO₃ | | | | | | |

Note-
“J” qualifier indicates that the value was below the analytical reporting limit but above the instrument detection limit.
“—” indicates the parameter was not analyzed.

The results show that 80% of the manganese can be removed. However, similar to the other tests, the removal occurred within the limestone batches as opposed to during sparging. The initial pH did not appear to have any effect on the manganese removal efficiency.

### PHREEQC Modeling Results

PHREEQC uses a term called the saturation index (SI) to quantify the degree of saturation of a mineral. SI is defined as follows:

SI=Log(IAP/Kₛₚ) (Eq. 12)

Where IAP is the ion activity product and Kₛₚ is the solubility product constant for the phase in question. For phases at saturation, IAP=Kₛₚ and SI=0. A negative SI indicates that the phase is unsaturated (IAP<Kₛₚ) while a positive SI (IAP>Kₛₚ) indicates the phase is supersaturated. In practice, a range of 0±0.5 SI units is considered saturated due to uncertainties in analytical and thermodynamic data.

### Phase 2—Test 1—HCl Addition to pH 5.3, 5.0, 4.5, and 4.0

PHREEQC was used to determine if carbon dioxide was escaping from the bottles during the 2-hour reaction time with the limestone. Two different types of simulations were performed.

Simulation 1A—Simulation in which unlimited calcite was added to the adit water within a closed system and allowed to reach equilibrium (saturation). Carbon dioxide was not equilibrated with the atmosphere, but was instead allowed to build up within the system.

Simulation 1B—The analyses from the batch test were input into PHREEQC and the carbon dioxide partial pressure was calculated (based mainly on the pH and alkalinity).

Loss of carbon dioxide would be evident if the results of the first simulation were different from the second one. The results are shown in Table 15.

TABLE 15
PHREEQC Simulation Within the Batches

| | PHREEQC Predicted | | | Actual | | |
|---|---|---|---|---|---|---|
| | pH | | | pH | | |
| Initial | Following | pCO₂ | Calcite | Following | pCO₂ | Calcite |
| pH | limestone | (atm) | SI* | limestone | (atm) | SI |
| 5.3 | 7.73 | 10^{-2.68} | 0.00 | 7.67 | 10^{-2.65} | −0.09 |
| 5 | 7.71 | 10^{-2.65} | 0.00 | 7.73 | 10^{-2.67} | 0.04 |
| 4.5 | 7.68 | 10^{-2.61} | 0.00 | 7.49 | 10^{-2.42} | −0.17 |
| 4 | 7.64 | 10^{-2.56} | 0.00 | 7.63 | 10^{-2.52} | 0.02 |

*Set to zero in the model

The results of the predicted and actual simulations are very close, indicating that little or no carbon dioxide escaped from the bottles. Escape of carbon dioxide would have resulted in lower carbon dioxide partial pressures and higher pH values for the actual system compared to the model prediction.

A second set of PHREEQC simulations were performed for the post-sparging solution to determine if calcite reached saturation during sparging. Again, two simulations were performed as follows:

Simulation 2A—The solution from above (Simulation 1A) was equilibrated with atmospheric carbon dioxide levels (10-3.5 atm at sea level) and calcite was allowed to precipitate.

Simulation 2B—The post-sparging solution was entered into PHREEQC and the saturation state of calcite was obtained.

TABLE 16
PHREEQC Simulation of the Post-Sparging Solutions

| | PHREEQC Predicted | | | Actual | | |
|---|---|---|---|---|---|---|
| | pH | | | pH | | |
| Initial | Following | pCO₂ | Calcite | Following | pCO₂ | Calcite |
| pH | limestone | (atm)** | SI* | limestone | (atm) | SI |
| 5.3 | 8.25 | 10^{-3.50} | 0.00 | 8.21 | 10^{-3.17} | 0.47 |
| 5 | 8.24 | 10^{-3.50} | 0.00 | 8.11 | 10^{-3.06} | 0.44 |
| 4.5 | 8.23 | 10^{-3.50} | 0.00 | 8.10 | 10^{-3.00} | 0.50 |
| 4 | 8.22 | 10^{-3.50} | 0.00 | 8.10 | 10^{-3.00} | 0.50 |

*Set to zero in the model
**Set to atmospheric value for seal level in model

A comparison of the predicted to the actual solutions shows that calcite should have precipitated, but did not. The saturation Index for calcite was greater than zero, but still within the ±0.5 SI units considered to be at saturation. The model predicted that about half of the calcium in solution should have precipitated as calcite (˜25 mg/L as Ca). Apparently, the 30 minutes reaction time for sparging was not long enough to reach equilibrium with respect to calcite. The reaction time used was based on previous work in which 30 minutes was found to be sufficient. However in the previous study, calcite was much more supersaturated, which is known to increase the precipitation rate (Plummer et al., 1978).

The reason for the removal of copper, zinc, and manganese may be due to adsorption onto the surfaces of the limestone or via precipitation of metals-bearing solid phases. PHREEQC was used to determine the saturation states of various copper, zinc, and manganese minerals, as shown in Table 17.

TABLE 17
Saturation State of Copper, Zinc and Manganese Phases

| | Saturation Indices | | | | |
|---|---|---|---|---|---|
| Initial | Malachite | Tenorite | Hydrozincite | Smithsonite | Rhodochrosite |
| pH | Cu₂(OH)₂CO₃ | CuO | Zn₅(OH)₆(CO₃)₂ | ZnCO₃ | MnCO₃ |

After Limestone/Pre-sparging

| | | | | | |
|---|---|---|---|---|---|
| 5.3 | **0.03 | **−0.43 | −6.83 | −1.65 | −0.69 |
| 5 | **0.43 | **−0.22 | −5.17 | −1.33 | **−0.49 |
| 4.5 | **0.44 | **−0.34 | −7.64 | −1.68 | −0.81 |
| 4 | *2.14 | **0.5 | −3.64 | −0.97 | **−0.25 |

Post Sparging

| | | | | | |
|---|---|---|---|---|---|
| 5.3 | −0.73 | **−0.54 | −3.81 | −1.35 | **−0.26 |
| 5 | **−0.13 | **−0.28 | −3.05 | −1.13 | **−0.2 |
| 4.5 | **−0.31 | **−0.39 | −4.17 | −1.32 | **−0.3 |
| 4 | *1.7 | *0.55 | **−0.34 | −0.58 | **0.11 |

The cells with two asterisks (**) represent phases at saturation within the solutions, while cells with one asterisk (*) represent super-saturated phases. The phases which are saturated are likely in equilibrium, meaning that the phase is potentially precipitating from the solution. Supersaturated phases have the potential to precipitate, but are not in equilibrium due to short reaction times compared to the rates of precipitation. The copper minerals tenorite and malachite both appear to be in equilibrium within the batches and during sparging, suggesting that the formation of these minerals are at least partly responsible for the observed removals. Zinc is largely undersaturated with respect to both hydrozincite and smithsonite, suggesting that adsorption onto the calcite is the main removal mechanism. Rhodochrosite is at saturation in both the batches and the sparged solution, suggesting that precipitation of this phase from solution is responsible for the observed manganese removals.

Phase 2—Test 2-H₂SO₄ Addition to pH 5.3, 5.0, 4.5, and 4.0

The results of the phase 2, Test 2 batches are presented in Table 18.

TABLE 18
Saturation State of Copper, Zinc and Manganese Phases and Calcite

| | | Saturation Indices | | | | | |
|---|---|---|---|---|---|---|---|
| Initial | Calcite | Malachite | Tenorite | Hydrozincite | Smithsonite | Rhodochrosite | Manganite |
| pH | CaCO₃ | Cu₂(OH)₂CO₃ | CuO | Zn₅(OH)₆(CO₃)₂ | ZnCO₃ | MnCO₃ | MnOOH |

After Limestone

| | | | | | | | |
|---|---|---|---|---|---|---|---|
| 5.3 | ** −0.06 | ** −0.19 | −0.62 | −7.08 | −1.68 | ** −0.2 | −1.38 |
| 5 | ** 0.04 | ** −0.17 | −0.68 | −6.87 | −1.58 | ** −0.13 | −1.23 |
| 4.5 | ** −0.49 | * 1.02 | ** −0.19 | −7.51 | −1.59 | ** −0.53 | −2.31 |
| 4 | ** −0.21 | ** 0.11 | ** −0.52 | −6.74 | −1.58 | ** −0.32 | ** 0.00 |

After Sparging

| | | | | | | | |
|---|---|---|---|---|---|---|---|
| 5.3 | ** 0.4 | −0.59 | ** 0.06 | −4.31 | −1.39 | ** −0.27 | ** −0.48 |
| 5 | ** 0.38 | −0.94 | −0.75 | −5.31 | −5.31 | ** −0.4 | −0.69 |
| 4.5 | ** 0.18 | ** −0.02 | ** −0.34 | −3.63 | −1.2 | ** −0.25 | −0.62 |
| 4 | ** 0.39 | −0.72 | −0.65 | −4.73 | −1.47 | ** −0.39 | −0.77 |

The results show that calcite, and rhodochrosite are consistently at saturation for the pre-sparging samples, indicating that calcite reached saturation and that manganese concentrations within the limestone batches were potentially controlled by precipitation of rhodcrosite. Tenorite and malachite were at or near saturation for all of the pre-sparging samples, indicating that copper concentrations could have been controlled by these phases. Zinc phases (hydrozincite and smithsonite) were very undersaturated, suggesting that zinc concentrations were controlled by adsorption or potentially by solid-solution phases (not within the PHREEQC database).

Calcite is slightly supersatured within the post-sparging samples, although it is within the 0±0.5 SI unit criteria usually applied to a solution at saturation. Again, the saturation state of calcite was not high enough to result in precipitation due to slow reaction kinetics near saturation. Again, manganese concentrations appear to have been controlled by precipitation of rhodocrosite, copper concentrations by malachite and/or tenorite and zinc by adsorption.

### Phase 2—Test 3-SO₄ (Sulfate) Addition pH 4.0

The results of the PHREEQC modeling for the sulfate-added batches is presented in Table 19.

TABLE 19
Saturation State of Copper, Zinc and Manganese Phases and Calcite, and Gypsum

| | | | Saturation Indices | | | | |
|---|---|---|---|---|---|---|---|
| SO4 | | Gypsum | | | | | |
| Added | Calcite | CaSO₄ | Malachite | Tenorite | Hydrozincite | Smithsonite | Rhodochrosite |
| (mg/L) | CaCO₃ | 2H₂O | Cu₂(OH)₂CO₃ | CuO | Zn₅(OH)₆(CO₃)₂ | ZnCO₃ | MnCO₃ |

After Limestone

| | | | | | | | |
|---|---|---|---|---|---|---|---|
| 100 | ** −0.11 | −1.59 | ** 0.14 | ** −0.47 | −7.12 | −1.7 | −0.73 |
| 300 | ** 0.00 | −1.33 | −0.56 | −0.69 | −6.27 | −1.67 | −0.7 |
| 500 | ** 0.09 | −1.14 | −0.7 | −0.75 | −6.69 | −1.77 | −0.63 |
| 700 | ** 0.05 | −1.09 | −0.85 | −0.78 | −7.61 | −1.99 | −0.8 |

After Sparging

| | | | | | | | |
|---|---|---|---|---|---|---|---|
| 100 | ** 0.47 | −1.54 | −0.55 | ** −0.47 | −5.06 | −1.63 | ** −0.31 |
| 300 | ** 0.33 | −1.24 | −0.93 | −0.68 | −5.72 | −1.75 | ** −0.48 |
| 500 | ** 0.33 | −1.15 | −1.00 | ** −0.43 | −5.34 | −1.7 | ** −0.43 |
| 700 | ** 0.29 | −1.06 | −1.06 | −0.74 | −6.29 | −1.84 | −0.64 |

The results are consistent with tests 1 and 2. The addition of up to 700 mg/L sulfate did not result in the precipitation of gypsum and had little or no effect on the saturation states of most of the other minerals. The exception was rhodocrosite within the pre-sparging samples, which appeared to have been undersaturated. The speciation data suggest that the added sulfate formed MnSO₄⁰ aqueous complexes in solution which increased the solubility of rhodocrosite.

### Phase 2—Test 4—Mn Addition pH 4.0 and 5.0

The results of the PHREEQC modeling for the batches to which 5.0 mg/L manganese was added are presented in Table 20.

TABLE 20
Saturation State of Copper, Zinc and Manganese Phases, and Calcite

| | | Saturation Indices | | | | |
|---|---|---|---|---|---|---|
| | Calcite | Malachite | Tenorite | Hydrozincite | Smithsonite | Rhodochrosite |
| Initial pH | CaCO₃ | Cu₂(OH)₂CO₃ | CuO | Zn₅(OH)₆(CO₃)₂ | ZnCO₃ | MnCO₃ |

After Limestone

| | | | | | | |
|---|---|---|---|---|---|---|
| 5 | ** −0.14 | ** −0.46 | −0.74 | −8.08 | −1.9 | * 0.7 |
| 4 | ** −0.08 | ** −0.53 | −0.77 | −8.1 | −1.92 | * 0.71 |

After Sparging

| | | | | | | |
|---|---|---|---|---|---|---|
| 5 | ** 0.41 | −0.97 | −0.73 | −5.14 | −1.64 | * 1.01 |
| 4 | ** 0.41 | −1.08 | −0.74 | −5.38 | −1.68 | * 1.01 |

The addition of manganese resulted in the supersaturation of rhodocrosite in both the pre-sparging and post-sparging samples. The supersaturation may have been caused by an inadequate sparging time. If calcite had precipitated, the rhodocrosite precipitation would have been favored as well.

### Difference Between Carbon Dioxide and Strong Acid for pH Adjustment

The lack of calcite precipitation for all of the laboratory tests is due to the fact that the amount of calcite dissolved was low (<100 mg/L) compared to Examples #1 and #2 conducted by CDM Smith (˜500 mg/L). In Examples #1 and #2, the greater amount of dissolution led to reprecipitation of a large mass of calcite (˜400 mg/L) within the 30 minutes of sparging. The much lower dissolution of calcite in Example #3 led to less supersaturation of calcite during sparging and slow precipitation rates, resulting in little or no precipitation of calcite. Therefore, the amount of calcite dissolution is an important component of the treatment.

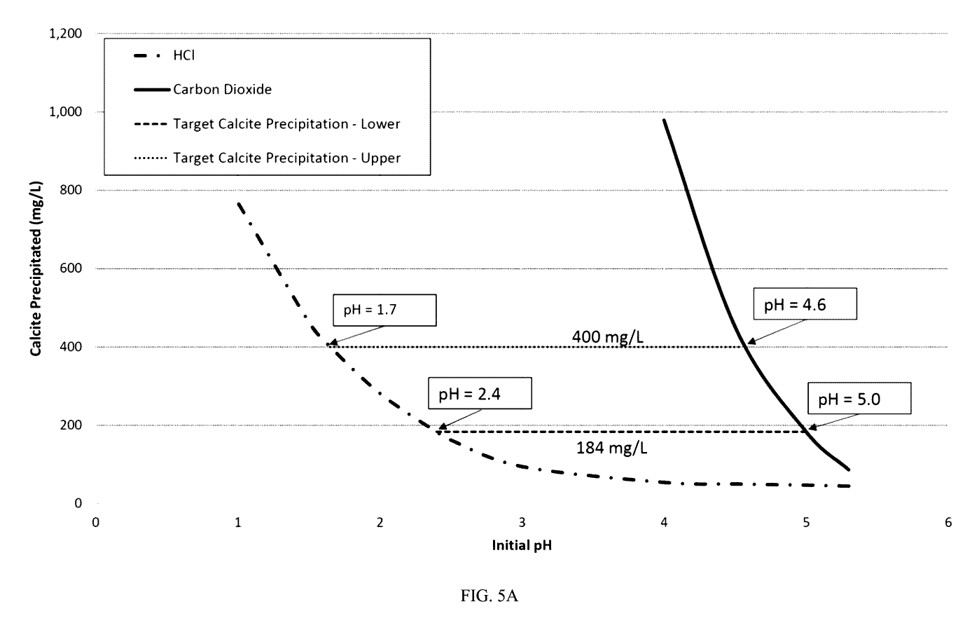

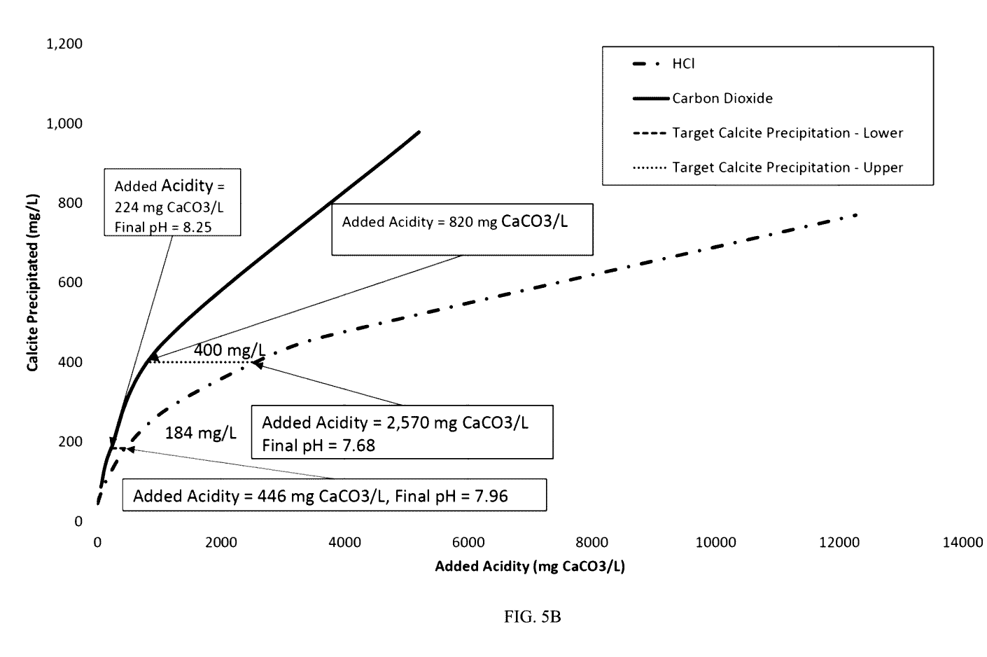

The main difference between Example #3 and Examples #1 and #2 is that strong acids were used for acid addition in Example #3 while carbon dioxide was used in Examples #1 and #2. The Phase 1 tests were designed to evaluate the differences between the two types of acid addition. However, due to possible escape of CO₂ during the long reaction time (24 hours), the results appeared to show that the type of acid was not important. In order to further explore the type of acid used, PHREEQC simulations were conducted using a wide range of initial pH values for both a strong acid (HCl) and for carbon dioxide (a weak acid). Comparison of PHREEQC simulated batch studies compared to the actual laboratory studies (presented and discussed in section 4.1) show that PHREEQC modeling simulate the actual systems very well. The results are shown in FIGS. 5A and 5B.

FIG. 5A is a plot showing the initial pH using hydrochloric acid (dashed and dotted line) and carbon dioxide (solid line) vs the amount of calcite reprecipitated (calculated using PHREEQC)

FIG. 5A shows that the use of carbon dioxide for acidity addition results in much more calcite reprecipitation than for HCl at a given initial pH. The pH values used in the present study (5.3, 5.0, 4.5, and 4.0) are along the flat portion of the HCl curve, explaining why the results within this pH range were essentially identical.

One possible explanation for the better performance of carbon dioxide is that by adding a weak acid (such as carbon dioxide) the actual acidity added is greater than for a strong acid such as HCl (at a given pH). FIG. 5B shows that for a given acidity addition, carbon dioxide is still superior to a strong acid. The difference appears to be the final pH (following sparging) is consistently higher when using carbon dioxide compared to HCl. The higher pH results in a greater amount of calcite reprecipitation even when the amount of calcite initially dissolved is the same.

### INCORPORATION BY REFERENCE AND EQUIVALENTS

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of removing one or more heavy metals from water contaminated with one or more heavy metals, comprising:
a) adding a source of calcium carbonate to the water under conditions to produce a solution of calcium carbonate; and
b) treating the solution of calcium carbonate to cause coprecipitation of calcium carbonate and the one or more heavy metals.

2. The method of claim 1, further comprising determining the pH of the water prior to adding a source of calcium carbonate to the water.

3. The method of claim 1, further comprising treating the water to produce lower-pH water having a desired pH prior to adding a source of calcium carbonate to the water.

4. The method of claim 3, wherein treating the water to produce lower-pH water having the desired pH comprises adding acid to the water.

5. The method of claim 3, wherein treating the water to produce lower-pH water having the desired pH comprises bubbling carbon dioxide through the water.

6. The method of claim 1, wherein treating the solution of calcium carbonate in step (b) comprises raising the pH of the solution of calcium carbonate.

7. The method of claim 6, wherein raising the pH of the solution of calcium carbonate comprises adding base to the solution.

8. The method of claim 6, wherein raising the pH of the solution of calcium carbonate comprises stripping carbon dioxide from the solution.

9. The method of claim 8, wherein stripping carbon dioxide from the solution of calcium carbonate is performed by bubbling air through the solution.

10. The method of claim 1, wherein treating the solution of calcium carbonate to cause the coprecipitation of step (b) is accomplished by adding a sufficient source of calcium carbonate in step (a) to produce a saturated solution of calcium carbonate.

11. The method of claim 1, wherein the source of calcium carbonate is limestone.

12. The method of claim 1, wherein adding a source of calcium carbonate is accomplished by adding reactants that form sufficient calcium carbonate to produce a saturated solution of calcium carbonate.

13. The method of claim 12, wherein the reactants that form calcium carbonate are calcium chloride and sodium carbonate.

14. The method of claim 1, wherein the one or more heavy metals comprise cadmium, lead, zinc, copper, manganese, nickel or combinations thereof.

15. The method of claim 1, wherein the water containing the one or more heavy metals is adit water or industrial waste water.

16. The method of claim 1, further comprising separating the coprecipitated calcium carbonate and one or more heavy metals from the water.

17. A method of removing one or more heavy metals from adit water contaminated with one or more heavy metals, comprising:
a) bubbling carbon dioxide through the water;
b) adding a source of calcium carbonate to the water under conditions to produce a solution of calcium carbonate;
c) bubbling air through the solution of calcium carbonate to coprecipitate calcium carbonate and the one or more heavy metals; and
d) separating the coprecipitated calcium carbonate and one or more heavy metals from the water.
